(19) United States
(12) Patent Application Publication
(10) Pub. No.: US 2021/0222481 A1
(43) Pub. Date: Jul. 22, 2021

(54) KRYPTON GAS FILLED COOLER DOOR

(71) Applicant: COMMERCIAL DISPLAY SYSTEMS, LLC, Canyon Country, CA (US)

(72) Inventor: FERNANDO CALDERON, GRANADA HILLS, CA (US)

(21) Appl. No.: 16/408,252

(22) Filed: May 9, 2019

Related U.S. Application Data
(60) Provisional application No. 62/673,055, filed on May 17, 2018.

(51) Int. Cl. E06B 3/67; A47F 3/04

(52) U.S. Cl. CPC E06B 3/6715; E06B 2003/6638; A47F 3/0434

(57) ABSTRACT

Refrigeration doors are disclosed having multiple glass panes with sealed air spaces between the panes. The air space can be filled with one or more inert gasses in high concentrations, and the surfaces of the panes can have different combinations of Low-E layers. In some embodiments, the inert gas can be used in concentrations up to 98% and the Low-E layers can be included on the inside surfaces of the glass panes. The gas and Low-E layer combinations give the refrigeration doors the desired visual and thermal characteristics. The present invention can be used with refrigerator doors, but it is understood that it can also be used in different doors used in different applications, and can also be use in windows.

This application claims the benefit of U.S. Provisional Patent Application No. 62/673,055 filed on May 17, 2018.

### BACKGROUND OF THE INVENTION

### Field of the Invention

The present invention relates to doors for commercial refrigerators or coolers, and in particular multiple pane cooler doors having Low-E layers and sealed air spaces between the panes filled with an inert gas.

### Description of the Related Art

Refrigeration doors for commercial freezers, refrigerators and the like are typically constructed of glass to allow the customer to view the products placed therein for sale without opening the door. However, when condensation forms on the glass (sometimes referred to as “fogging”), the customer is not able to see through the door to identify the products inside, which is undesirable from the standpoint of both the customer and the store owner or retailer. The formation of frost presents similar problems.

Moisture can condense on the outside of the glass refrigeration door due to the surface temperature of the glass being below the ambient temperature in the store near the colder refrigerated interior of the freezer or refrigerator. When the temperature of the surface of the glass drops below the dew point of the air in the store, moisture condenses on the surface of the glass. In addition, when a door is opened in a humid environment, the innermost sheet of glass, which forms the inside of the door, is also momentarily exposed to the ambient air of the store and condensation may form on the inside of the door as well. The condensation on the inside of the glass door also occurs because the temperature of the inside of the glass door is below the dew point of the ambient store air to which it is exposed.

When the customer's view of the products behind the glass door is obscured, the customer may not be able to see the products and may need to open the refrigeration door to identify the products inside. Opening the refrigeration door can be tedious and time consuming from the customer's perspective. It is also undesirable from the retailer's standpoint as well, since it significantly increases the energy consumption of the retailer's freezers and refrigerators, thereby resulting in higher energy costs to the retailer. The cool air can also be introduced into the ambient, which can increase heating cost for the retailer.

Some conventional approaches to preventing or reducing condensation in a refrigeration door involve supplying energy to the door by including a conductive coating on one or more of the glass surfaces of the door for electrically heating the glass. The purpose of heating the glass is to maintain the temperature of the glass above the dew point of the warmer ambient air of the store. By heating the glass above the dew point, the undesirable condensation and frost are prevented from forming on the glass in the door, providing a clear view through the glass to the interior of the refrigeration compartment.

In a three-pane door, an unexposed surface of one or two of the sheets of glass can be coated with a conductive material. The conductive coating is connected to a power supply by two bus bars or other electrical connectors mounted on opposite edges of the glass. As current passes through the coating, the coating heats, thereby heating the glass sheet to provide a condensation-free surface. The coating of a refrigeration door is normally applied to the unexposed surface of the outermost glass sheet. However, because condensation sometimes forms on the inside of the inner sheet of glass, the unexposed surface of the innermost sheet of glass may also be coated for heating to prevent condensation.

There are numerous drawbacks and problems associated with these conventional heated refrigeration doors of the prior art. First, heating the door incurs an energy cost above and beyond the energy costs of the cooling system. Considering that many stores utilize multiple freezers, with some supermarkets and other food retailers utilizing hundreds of freezers, the cumulative energy costs associated with such heated freezer doors are significant.

Second, excess heat from conventional heated refrigeration doors will migrate to the refrigeration compartment, creating an additional burden on the cooling system, which results in still greater energy costs. Third, if the power supplied to the door for heating is too low, is turned off, or is shut down due to a power outage, condensation and/or frost will form on the glass. If the power dissipation is too high, unnecessary additional energy costs will, be incurred. In order to reduce the occurrence of these problems, such heated glass doors often require precise control of the door heating system. In order to achieve the necessary precise control of the door heating system, an electrical, control system is required, which results in increased design and manufacturing costs, as well as substantial operational and maintenance costs.

Fourth, these electrically heated glass doors present a safety hazard to customers and a potential risk of liability and exposure to retailers and refrigeration system manufacturers. The voltage applied to the glass door coating is typically 115 volts AC. The shopping carts used by customers in stores are heavy and metal. If the shopping cart strikes and breaks the glass door, electricity may be conducted through the cart to the customer, which could cause serious injury or even death.

Low emissivity (Low-E) coatings have been employed as another means for reducing condensation on refrigeration doors. Specifically, one method of increasing the insulating value of glass (the “R value”) and reducing the loss of heat from the refrigeration compartment, is to apply a low emissivity (Low-E) coating to the glass. A low-E coating can a microscopically thin, virtually invisible metal or metallic oxide layer(s) deposited on a glass surface to reduce the emissivity by suppressing radiative heat-flow through the glass.

### SUMMARY OF THE INVENTION

Notwithstanding the available electrically heated and low emissivity coated refrigeration doors and available anti-fog and anti-frost products such as films and coatings, there is a need for a refrigeration door: (1) that provides the necessary condensation control and thermal insulation over a broad range of temperatures and environments; (2) with the desired amount of visible transmittance; (3) that avoids unnecessary energy costs and undue burden on the cooling system by eliminating the need for supplying electrical power to heat the door; (4) that does not require an expensive and complex electrical control system, thereby minimizing design, manufacturing, operation, and maintenance costs; and (5) that does not present a safety hazard to customers and a potential risk of liability and exposure to manufacturers and retailers, and that otherwise overcomes or reduces the problems described above.

The present invention is generally directed to refrigeration doors having multiple glass panes with sealed air spaces between the panes. The air space can be filled with one or more inert gasses, and the surfaces of the panes can have different combinations of Low-E layers. In some embodiments, the inert gas can be used in high concentrations, and the Low-E layers can be included on the inside surfaces of the glass panes. The gas and Low-E layer combinations give the refrigeration doors the desired visual and thermal characteristics, with some embodiment having a high inert gas concentration in their air space(s). The present invention can be used with refrigerator doors, but it is understood that it can also be used in different doors used in different applications, and can also be use in windows.

These and other features and advantages of the invention will be apparent to those skilled in the art from the following detailed description, taken together with the accompanying drawings.

### BRIEF DESCRIPTION OF THE DRAWINGS

FIG. 1 is a perspective view of one embodiment of a refrigeration system that can use refrigerator according to the present invention;

FIG. 2 sectional view of one embodiment of refrigeration door according to the present invention;

FIG. 3 is a sectional view of another embodiment of refrigeration door according to the present invention;

FIG. 4 is a sectional view of another embodiment of refrigeration door according to the present invention;

FIG. 5 is a sectional view of still another embodiment of refrigeration door according to the present invention;

FIG. 6 is a sectional view of one embodiment of a window according to the present invention;

FIG. 7 is a sectional view of still another embodiment of refrigeration door according to the present invention;

FIG. 8 is a sectional view of still another embodiment of refrigeration door according to the present invention;

FIG. 9 is a sectional view of still another embodiment of refrigeration door according to the present invention; and

FIG. 10 is a sectional view of still another embodiment of refrigeration door according to the present invention

### DETAILED DESCRIPTION OF THE INVENTION

The present inventions are directed to multiple pane cooler, freezer or refrigerator doors (“refrigeration doors” or “cooler doors”) that provide the desired thermal insulation over a broad range of temperatures and environments, with the desired amount of visible transmittance and while not consuming excess power. Some embodiments can provide these advantages with remaining energy consumption free. The refrigeration doors can be used with conventional refrigerated display cases with the panes of the doors having different coating combinations and sealed air space filled with high concentration inert gas. The combination of layers and gas provides for improved refrigeration doors that exhibit improved thermal characteristics, reduced moisture build-up with some embodiments operating without electrical heating. The description below is directed to cooler doors it is understood that the present invention can also be applied to many different arrangements having glass and designed for seeing through, including residential or commercial windows or doors.

The refrigeration doors according to the present invention comprises two, three or more panes of glass sealed at their peripheral edges by a spacer or other sealant assembly, generally referred to as an edge seal. Some embodiments of a refrigeration door comprise three sheets of glass and two insulating chambers a formed between the three sheets of glass. In a door comprised of two sheets of glass, a single insulating chamber is formed. Typically, doors for refrigerators can be constructed of two sheets or panes of glass, while doors for freezers can employ three panes of glass. Once sealed, the air spaces or chambers can be filled with an inert gas or suitable gas to improve the thermal performance of the door. It is understood that other doors can have more panes of and more than two air spaces for inert gas.

In some embodiments, the different panes in the cooler doors can be coated with a low emissivity (“Low-E”) layer or coating on one or more surfaces. Low-E coatings can be employed as another means for reducing condensation on refrigeration doors. Specifically, one method of increasing the insulating value of glass (the “R value”), and reducing the loss of heat from the refrigeration compartment, is to apply a Low-E coating to the glass.

As discussed above Low-E coatings can comprise a thin, virtually invisible metal or metallic oxide layer(s) deposited on a glass surface to reduce the emissivity by suppressing radiative heat-flow through the glass. In some embodiments, the Low-E coating can be microscopically thin. Emissivity is the ratio of radiation emitted by a black body or a surface, and the theoretical radiation predicted by Planck's law. The term emissivity is used to refer to emissivity values measured in the infrared range by the American Society for Testing and Materials (ASTM) standards. Emissivity is measured using radiometric measurements and reported as hemispherical emissivity and normal emissivity. The emissivity indicates the percentage of long infrared wavelength radiation emitted by the coating. A lower emissivity indicates that less heat will be transmitted through the glass. Consequently, the emissivity of a sheet of glass impacts the insulating value of the glass as well as the heat conductivity (the “U value”) of the glass. The U value of a sheet of glass or of an IGU is the inverse of its R value.

Low-E coated glass provides certain advantage such as a low rate of emission. For example, if the Low-E glass were used on a home window, and there is a heat source inside the house, the Low-E glass bounces the heat from that object and reflects back away from the glass. In winter months, if you have Low-E glass in your home, much of the warmth (heat) given off from inside the house, such as by the furnace and all the objects which the furnace has heated, can be bounced back into the room. In the summer, the same thing happens but in reverse. The sun generates heat in the air and from sidewalks, driveways, etc. This heat radiates from those objects and can spread into the house. The heat tries to take the path of least resistance, such as the glass. With Low-E glass, much of this heat bounces off the glass and stays outside.

There are two types of Low-E glass: hard coat and soft coat. Hard coat Low-E glass is manufactured by pouring a thin layer of molten metal onto a sheet of glass while the glass is still slightly molten. The tin actually becomes “welded” to the glass. This process makes it difficult or “hard” to scratch or remove the tin and often this glass has a blueish tint to it. Many different metals can be used in this process such as silver, zinc or tin.

Soft coat Low-E glass, on the other hand, involves the application of a metal layer in a vacuum. The glass enters a vacuum chamber filled with an inert gas which is electrically charged. The electricity combined with the vacuum allows molecules of metal to sputter onto the glass. The method can also use different metals such as silver, zinc and tin, and the coating can be relatively delicate or “soft.” Furthermore, if silver is used for a soft Low-E coating, the coating can oxidize if exposed to normal air. For this reason, soft coat Low-E glass most often is used in an insulated glass assembly. Sealing the soft coating in between two pieces of glass protects the soft coating from outside air and sources of abrasion. Also, the space between the two pieces of glass is often filled with argon gas. The argon gas inhibits oxidation of the metallic coating. It also acts as an additional insulator.

The two types of Low-E glass have different performance characteristics. The soft coat process can have the ability to reflect more heat back to the source. It typically has a higher R value. R values are a measure of resistance to heat loss. The higher the R value of a material, the better its insulating qualities. Below shows a comparison of R values and the different types of glass.

TABLE ONE
GLASS R VALUES

| Type of Glass | R Value |
|---|---|
| Single Pane regular glass | 0.85 |
| Clear Insulated Glass ⅞-inch overall thickness | 2.08 |
| Hard Coat Low-E insulated glass | 2.45 |
| Hard Coat Low-E insulated glass with argon | 2.75 |
| Soft Coat Low-E Insulated Glass | 3.50 |
| Soft Coat Low-E insulated glass with argon | 4.35 |

Low-E coatings can comprise different combinations of metals, metal oxides, and other materials, and can be provided in multiple layers. In some embodiments, the different materials can comprise ceramics. Some Low-E layers can comprise multiple layers of differing thicknesses, with some Low-E layer are comprising up to a dozen or more layers of metals and ceramics. This Low E layer can have different thickness, with some embodiments having a thickness in the range of hundreds of nanometers, with one embodiment having a thickness in the range of 100 to 1000 nanometers. Other embodiments can have thickness of less than 100 nanometers, with some layers measuring only one nanometer in thickness. One embodiment of a Low-E coating can have up to three silver layers and multiple ceramic layers. The layers according to the present invention can result in doors or windows that can provide as much as 70% or more visible light transparency while providing the desired thermal characteristics.

While Low-E coatings have been applied to glass panes in refrigeration doors both with and without electrically heating the doors, such coatings and resulting surfaces may not be adequately capable of controlling condensation. They may also not be able to provide the desired thermal insulation through the broad range of temperatures and environments in which such refrigeration doors are utilized without applying electricity to heat the doors. More specifically, notwithstanding the use of such low E coatings, refrigeration doors that are not heated have failed to provide condensation control in applications in which the interior temperature of the refrigeration compartment is substantially near or below freezing.

The present invention provides refrigeration doors with improved combinations of Low-E coated glass and sealed air spaces filled with high concentrations of inert gas. In some embodiments, this inert gas can comprise krypton gas. This combination results in refrigeration doors with the desired anti-fog and thermal characteristics, without the need for applying power.

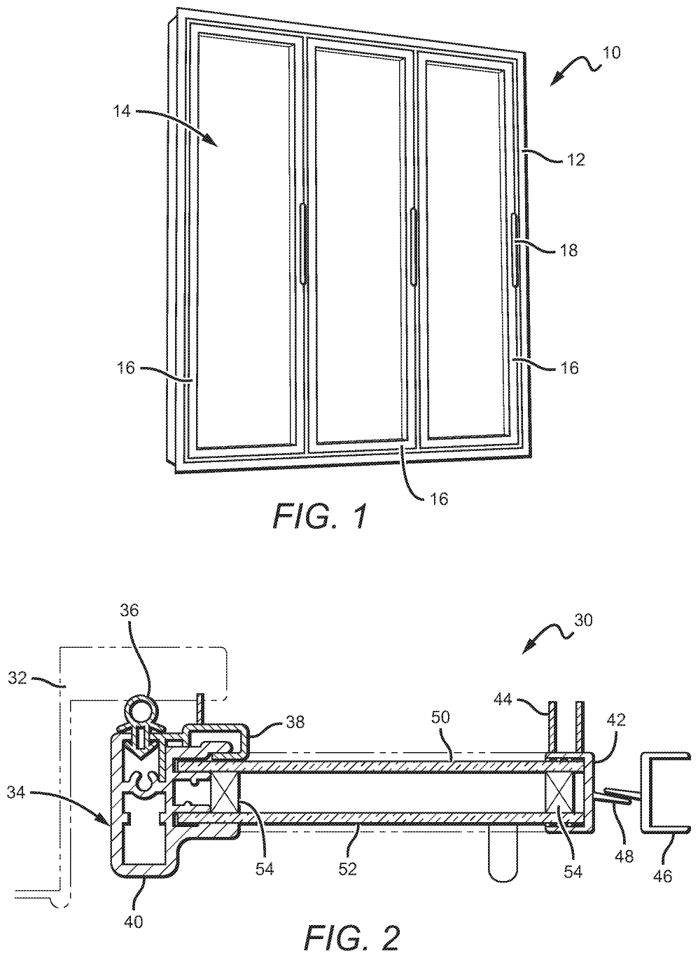

FIG. 1, shows one embodiment of a refrigeration system 10 that can use refrigeration doors according to the present invention. A door frame 12 is included that can be coupled to the refrigeration compartment 14 in any suitable fashion known in the art. Refrigeration doors 16 can be attached to the door frame such as by a single door long hinge, multiple hinges, or in a slot for sliding the door open and closed. In addition, the frame may include a door handle 18 or other suitable actuating means as is appropriate for opening the door in the particular application.

FIG. 2 shows one embodiment of a refrigeration door 30 according to the present invention that can be moveably attached to refrigeration frame 32 by a door hinge assembly 34. Many different hinge assemblies can be used and can include many different features such as those described in U.S. Pat. No. 6,978,516, assigned to the assignee of the present application and incorporated by reference in its entirety. The hinge assembly can comprise many different features such as a hinge seal 36, a hinge cover seal 38 and a hinge rail 40. The door can also comprise a handle rail 42 that is opposite the hinge rail 40, with the handle rail 42 also having a flexible sealing 44. The handle rail 42 and opposing handle rail 46 can each have opposing portions of a handle rail seal 48 that overlap to provide a seal between the handle rails 44, 46.

The cooler door 30 can further comprise a first glass pane 50 having an inside and an outside surface, and a second glass pane 52 having an inside and an outside surface. As described below a Low-E coating can be included on the inside surface of the first and/or second glass pane 50, 52. In other embodiments an intermediate glass pane can be included between the first and second glass panes 52 with a Low-E layer on one or both of the intermediate layer's surfaces. A spacer 54 can be included between the first and second glass panes 50, 52 and in the embodiment having an intermediate glass pane, a second spacer can be included as described in more detail below. In most embodiments, the first and second glass panes have widths and heights that are identical. The spacer 54 can be disposed around the periphery of said second pane of glass and said first-pane of glass for maintaining first and second panes in spaced-apart relationship from each other and to form a sealed air space between the two panes as further described below.

Spacers utilized in the refrigeration doors according to the present invention can be made of different materials and can be formed in a seal around the pane periphery in many different ways. In some embodiments the spacer can comprise stainless steel. In other embodiments, the spacer can comprise a hybrid combination of metal and plastic, with some of these hybrid spacers having a longitudinal cavity that can be filled with desiccant to help with moisture control. In some embodiments, the metal and plastic in the hybrid combinations can have small holes to allow for moisture to pass through to the desiccant. The spacers can either be bent in a shape to match the door periphery or can be formed in different sections to match the edges of the door periphery. Adhesives can also be included on the spacer to allow for adhesion to the surface of the panes and to enhance the seal made in the air space.

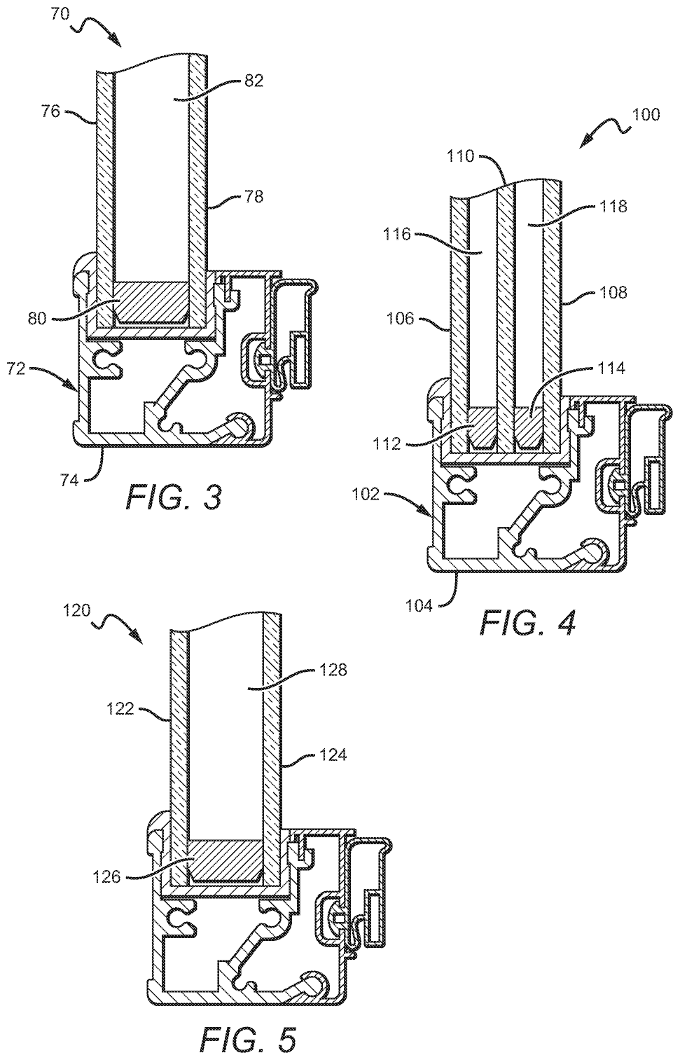

FIG. 3 shows another embodiment of a cooler door 70 according to the present invention having a hinge 72 and a hinge rail 74 similar to those described above. The door 70 further comprises a first glass pane 76 and a second glass pane 78 mounted in the hinge with spacer 80 between the two. In this embodiment the outer surface of the first glass pane 76 and the outer surface of the second glass pane 78 are clear or uncoated. The inner surface of the first glass pane 78 and the inner surface of the second glass pane 78 are coated with a soft Low-E layer as described above. It is understood that in other embodiments one or more of the outer and inner surfaces of the glass panes can be coated by hard Low-E layer as described above. The door 70 further comprises a sealed air space 82 between the first and second glass panes and the spacer 80. The space can be filled with an inert gas of the type that increases the insulation characteristics of the cooler door 70 compared to door without the inert gas.

In this embodiment, the inert gas can comprise krypton gas and can fill the space with a gas concentration that can be up to 100% concentration to provide the most insulation. In some embodiments, the gas concentration can be in the range of 50% to 98%. In other embodiments, the gas concentration can be in the range of 75% to 95%. In some embodiments used in extreme cooler applications in high humidity environments, the gas percentage can be up to 95% or more. It is understood that gasses can be included in other concentrations, such as less than 50%. Other inert gases can be used beyond krypton, including helium (He), neon (Ne), argon (Ar), xenon (Xe), and radon (Rn), or different combinations of these gases.

The cooler door 70 can be used in many different types of coolers, freezers or refrigerators. Some application can be for a cooler door used in moderate condition coolers where the case temperature is in the range of 35-38 degrees F., and the ambient is 80 degrees F. or less. It is understood that the door 70 can be used with freezers or refrigerators used in lower or higher case temperatures and in ambient temperatures that are higher than 80 degrees F. It is also understood that the door 70 can be used in environments of different ambient humidity, with some doors used in ambient humidity of higher than 10%, higher than 35%, or higher than 55%.

FIG. 4 shows another embodiment of a cooler door 100 according to the present invention having a hinge 102, hinge rail 104, first glass pane 106 and a second glass pane 108, similar to those described above. An intermediate glass pane 110 is included between the first and second panes 106, 108 with first and second spacers 112, 114 disposed around the periphery of the panes to form first and second sealed air spaces 116, 118.

Like the embodiments above, different surfaces can have different Low-E layers and others can be clear. In the embodiment shown the outer surfaces of the first glass pane 106 and the outer surface of the second glass pane 108 are clear. The inner surface of the first glass pane 106 and the inner surface of the second glass pane 108 can be coated with a soft Low-E layer as described above. The surfaces of the intermediate pane 110 can be clear. It is understood that in other embodiments one or more of the outer and inner surfaces of the glass panes can be coated by hard or soft Low-E layer as described above.

The first and second air spaces 116, 118 can be filled with an inert gas of the type that increases the insulation characteristics of the cooler door 100 compared to a door without the inert gas. In this embodiment, the inert gas can comprise krypton gas and can fill the space with gas having concentrations described above. It is understood that the gas can be included in other concentrations and that other inert gases can be used as described above, including argon.

The cooler door 100 can be used in many different type of coolers, freezers or refrigerators. One application for the cooler door can be for extreme condition coolers with the case temperature in the range of 35-38 degrees F., the ambient is 85 degrees F. or less. Another application for the cooler door can be for normal condition coolers with the case temperature of approximately −10 degrees F., the ambient is 75 degrees F. or less. These are only some of the temperatures that the door 100 can be used in, and it can be used in higher or lower case temperatures and higher or lower ambient temperatures. Like above, the door 100 can be used in different ambient humidity, with some doors used in ambient humidity of higher than 10%, higher than 35%, or higher than 55%.

FIG. 5 shows another embodiment of a cooler door 120 that is similar to the door 70 shown in FIG. 3 and described above. Door 120 comprises first and second glass panes 122, 124, spacer 126 and air space 128. In this embodiment, the inner surface of the first glass pane 122 is coated with soft Low-E layer, while all the remaining surfaces are clear. The space 128 can be filled with krypton gas or other inert gas as described above.

The cooler door 120 can be used in many different types of coolers, freezers or refrigerators. One application for the cooler door can be for normal condition coolers with the case temperature in the range of 35-38 degrees F., the ambient is 75 degrees F. or less. Like above, the door 120 can be used with freezers or refrigerators used in lower or higher case temperatures and in ambient temperatures that are higher than 75 degrees F. It is also understood that the door 120 can be used in environments of different ambient humidity like the doors described above, with some doors used in ambient humidity of higher than 10%, higher than 35%, or higher than 55%.

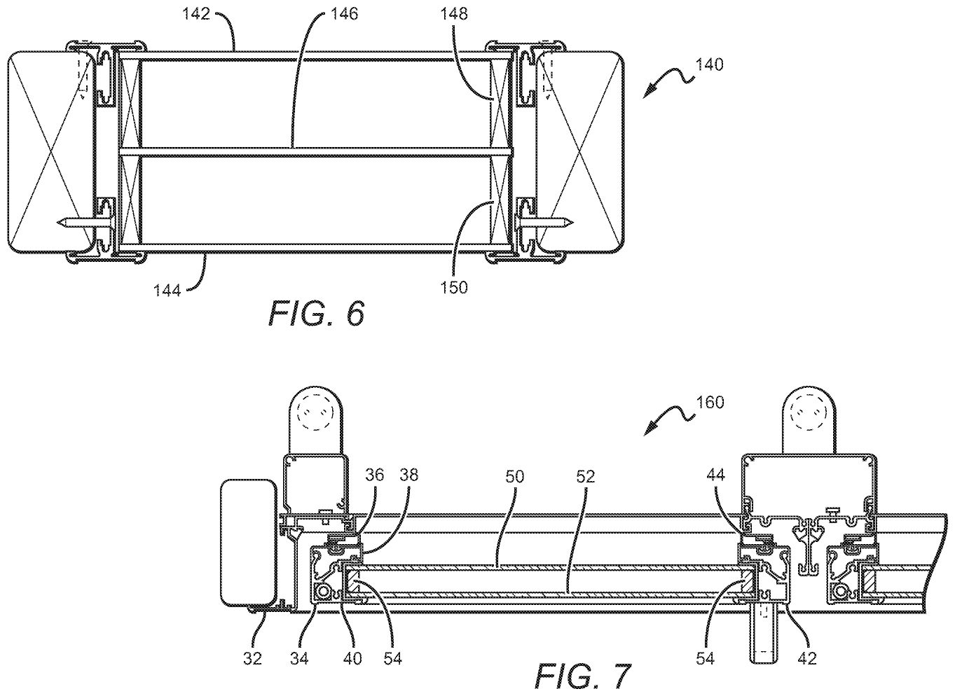

It is understood that the layer and inert gas arrangement used for the cooler doors can also be used for commercial or residential doors and windows. FIG. 6 shows one embodiment of a three-pane window 140 according to the present invention having first, second and intermediate panes 142, 144, 146 separated by first and second spacers 148, 150, to form first and second sealed air spaces. Like the embodiments above, the window can have different Low-E layers on different surfaces of the panes, and the spaces 148, 150 can be filled with an inert gas to the concentration described above.

It is understood that the present invention can be used in many different doors and windows that can be arranged in many different ways and with many different features beyond those described above. FIG. 7 shows another embodiment of a refrigerator door 160 that is similar to the refrigerator door 30 shown in FIG. 2 and described above. For the same or similar features, the same reference numbers are used. The door 160 can be moveably attached to refrigeration frame 32 by a door hinge assembly 34. The hinge assembly can comprise many different features such as a hinge seal 36, a hinge cover seal 38 and a hinge rail 40. The door can also comprise a handle rail 42 that is opposite the hinge rail 40, with the handle rail 42 also having a flexible sealing 44. A handle 162 can be attached to the handle rail 42 and can be used for opening the door 160.

The cooler door 30 can further comprise a first glass pane 50 having an inside and an outside surface, and a second glass pane 52 having an inside and an outside surface. A Low-E coating as described above can be included on the inside surface of the first and/or second glass pane 50, 52. In other embodiments an intermediate glass pane can be included between the first and second glass panes 52 with a Low-E layer on one or both of the intermediate layer's surfaces. A spacer 54 as described above can be included between and around the periphery of the first and second glass panes 50, 52. The door 160 can comprise different features that function much in the same way, with the door having different sealing mechanisms arranged in different ways.

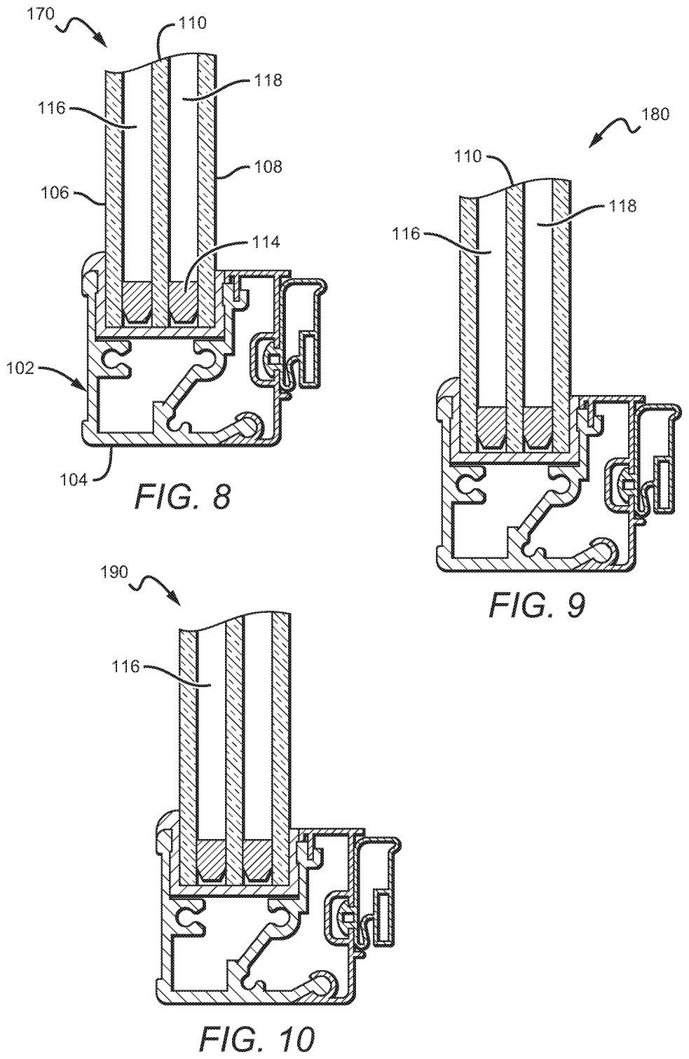

FIGS. 8 through 10 show additional embodiments of refrigerator doors that can be arrange to operate in environments having temperatures up to 75 degrees or higher. The doors can be used in refrigerator cases with temperatures in the range of 35-38 degrees or lower, such as applications with temperature of approximately −10 degrees or lower. The doors can also be used in cases with higher temperatures. It is understood that the doors can also be used with freezers or refrigerator used in lower or higher case temperatures and in ambient temperatures that are higher than 75 degrees F. It is also understood that these doors can be used in environments of different ambient humidity, with some doors used in ambient humidity of higher than 10%, higher than 35%, or higher than 55%.

FIG. 8 shows a cooler or refrigerator door 170 that is similar to the door 100 as shown in FIG. 4 and described above. The door 170 has a hinge 102, hinge rail 104, first glass pane 106 and a second glass pane 108, similar to those described above. An intermediate glass pane 110 is included between the first and second panes 106, 108 with first and second spacers 112, 114 disposed around the periphery of the panes to form first and second sealed air spaces 116, 118.

Like the embodiments above, different surfaces can have different Low-E layers and others can be clear. In the embodiment shown the outer surfaces of the first glass pane 106 and the outer surface of the second glass pane 108 are clear. The inner surface of the first glass pane 106 and the inner surface of the second glass pane 108 can be coated with a soft Low-E layer as described above. The surfaces of the intermediate pane 110 can be clear, but in other embodiments can have a Low-E layer. It is understood that in other embodiments one or more of the outer and inner surfaces of the glass panes can be coated by hard or soft Low-E layer as described above. Like the embodiment above, the first and second air spaces 116, 118 can be filled with an krypton gas of the type that increases the insulation characteristics of the cooler door compared to a door without the inert gas.

FIG. 9 shows another embodiment of a door 180 that has the same features and door 170 in FIG. 8 except for the location of the Low-E layers. In door 180 a soft Low-E layer is provided on the one or both of the surfaces of the intermediate glass pane 110. The surfaces of the pane 118 are clear and the inside surface of the pane 116 has a Low-E layer. This arrangement of panes and Low-E layers allows for operation of a door under the same environment conditions as door 170 in FIG. 8.

FIG. 10 shows still another embodiment of a door 190 wherein all the surfaces of the panes are clear except for the inside surface of pane 116, which comprises a Low-E layer. This door can also operate under the same environmental conditions, but may have different type or thickness of Low-E layer along with different concentrations of krypton gas.

Although the present invention has been described in detail with reference to certain preferred configurations thereof, other versions are possible. Therefore, the spirit and scope of the invention should not be limited to the versions described above. The foregoing is intended to cover all modifications and alternative methods falling within the spirit and scope of the invention. No portion of the disclosure is intended, expressly or implicitly, to be dedicated to the public domain if not set forth in any claims.

I claim:

1. A door or window, comprising:
two or more glass panes with spacers between adjacent ones of said glass panes;
a sealed air space between adjacent ones of the panes;
an inert gas in said air space having a concentration of greater that 70%; and
a Low-E layer on at least one surface of said glass panes.

2. The door or window of claim 1, comprising a cooler door with 3 or more panes of glass.

3. The door or window of claim 1, wherein said inert gas comprises krypton (Kr), helium (He), neon (Ne), argon (Ar), xenon (Xe), and radon (Rn), or different combinations of these gases.

4. The door or window of claim 1, wherein said inert gas comprises krypton (Kr) gas.

5. The door or window of claim 1, wherein said Low-E layer comprises metal or metal oxide.

6. The door or window of claim 1, where said Low-E layer comprises a metal.

7. The door or window of claim 1, wherein said low-E layer comprises silver, zinc, tin, or combinations thereof.

8. The door or window of claim 1, wherein said Low-E layer comprises a metal layer and a ceramic layer.

9. The door or window of claim 1, wherein said Low-E layer comprises a plurality of metal layers and a plurality of ceramic layers.

10. The door or window of claim 1, wherein said inert gas has a concentration in the range of 50% to 98%.

11. The door or window of claim 1, wherein said inert gas has concentration can be in the range of 75% to 95%.

12. The door or window of claim 1, having three panes of glass and two sealed air spaces.

13. A refrigerator/freezer, comprising:
a cooled area,
one or more doors operable to gain access to said cooled area, wherein said doors comprise;
two or more glass panes with spacers between adjacent ones of said glass panes;
a sealed air space between adjacent ones of the panes;
an inert gas in said air space having a concentration of greater that 80%; and
a Low-E layer on at least on the inside surface of at least one of said glass panes.

14. The refrigerator/freezer of claim 13, wherein said inert gas comprises krypton (Kr), helium (He), neon (Ne), argon (Ar), xenon (Xe), and radon (Rn), or different combinations of these gases.

15. The refrigerator/freezer of claim 13, wherein said inert gas comprises krypton (Kr) gas.

16. The refrigerator/freezer of claim 13, wherein said Low-E layer comprises metal or metal oxide.

17. The refrigerator/freezer of claim 13, wherein said low-E layer comprises silver, zinc, tin, or combinations thereof.

18. The refrigerator/freezer of claim 16, wherein said Low-E layer further comprises a ceramic layer.

19. The refrigerator/freezer of claim 13, wherein said Low-E layer comprises a plurality of metal layers and a plurality of ceramic layers.

20. The refrigerator/freezer of claim 13, wherein said inert gas has a concentration in the range of 50% to 98%.

21. The refrigerator/freezer of claim 13, wherein said inert gas has concentration can be in the range of 75% to 95%.
